(19) United States
(12) Patent Application Publication
(10) Pub. No.: US 2011/0030294 A1
(43) Pub. Date: Feb. 10, 2011

(54) Interior pane units and window with interior pane

(76) Inventors: Patrick Leonard Clarson, Tomball, TX (US); John Leonard, Houston, TX (US)

Correspondence Address: Guy McClung, P.O. Box 2553, Rockport, TX, 78381-2553, US

(21) Appl. No.: 12/804,023

(22) Filed: Jul. 10, 2010

Related U.S. Application Data
(60) Provisional application No. 61/271,462, filed on Jul. 21, 2009.
(60) Provisional application No. 61/278,702, filed on Oct. 9, 2009.

(51) Int. Cl. E06B 3/28; E04B 1/66; E06B 3/964

(52) U.S. Cl. 52/203; 52/204.51; 52/741.4; 52/204.62

(57) ABSTRACT

Window with an interior pane; and an interior pane system having a frame unit, a pane unit connected to the unit, the pane unit having a pane, the frame unit applicable to a window, the window having an exterior pane, the window having a window opening, the frame unit sized and configured for positioning at the window opening; in some aspects, such a system including the window; and/or, in some aspects, such a system including a window cover connected to the frame. This abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### RELATED APPLICATIONS

The present invention and this application claim the benefit of priority under the Patent Laws of U.S. Application Ser. Nos. 61/271,462 filed Jul. 21, 2009 and 61/278,702 filed Oct. 9, 2009, both of which are co-owned with the present invention and are incorporated fully herein for all purposes.

### BACKGROUND OF THE INVENTION

1. Field of the Invention

This present invention is directed to window units, to interior units with an interior pane, and to shutter units with an interior pane.

2. Description of Related Art

A wide variety of windows, interior window units, shutter units for windows, interior storm windows, and parts thereof are known, including, but not limited to, the disclosures in U.S. Pat. Nos. 6,865,846; 6,691,461; 6,505,669; 5,649,389; 5,465,537; 5,419,085; 5,390,454; 4,996,793; 4,967,511; 4,592,180; 4,561,223; 4,473,980; 4,251,966; 4,079,558; 3,932,959; 3,691,687; 3,805,872; 3,653,317; 3,451,165; 3,214,231; 3,183,547; 3,133,324; 84,124; and D 321,256—all incorporated fully herein for all purposes.

In certain known interior shutter systems, a shutter unit has sufficient room for movable parts and/or louvers to operate. Typically in such systems a connection member around the shutter unit is attached within a structure to an interior wall adjacent an existing window.

### BRIEF SUMMARY OF THE INVENTION

The present invention discloses, in certain aspects, interior units for mounting inside a structure for use with an exterior window, the unit including an interior pane mounted within the unit. In certain aspects, systems according to the present invention include a pane which is mountable spaced-apart from an exterior pane of a window. In one particular aspect, an interior unit according to the present invention is an interior shutter unit. In certain aspects, an interior unit according to the present invention includes members for removably mounting the pane; for example, metal strips secured to the unit and magnetic strips either placeable over edges of the pane for magnetically holding the pane in place or holders connected to the pane and having magnets thereon, and/or tape(s).

The present invention discloses, in certain aspects, interior units for mounting inside a structure for use with an exterior window, the unit including a pane mounted within the unit, the units having connection members according to the present invention for connecting the unit to a wall around a window and slots in the connection members for receiving an interior pane or for receiving metal members against which a pane is held by magnetic strips. In one aspect the unit is an interior shutter unit. A window unit and/or pane unit according to the present invention may be used with a window cover, e.g., but not limited to a shade, a blind, a drape, a curtain, or an interior shutter.

The present invention discloses, in certain aspects, shutter units with a frame with a frame opening, a pane mount secured to the frame, and the pane mount suitable for holding a pane.

The present invention discloses, in certain aspects, connection members for connecting a unit to a wall adjacent a wall opening in the wall, the connection members including: a body with a front portion for positioning over a part of a wall at the opening; a second portion extending from the front portion; a pane mount secured to the second portion and suitable for holding a pane within the body so that a movable part of the unit is not interfered in movement by the pane.

The present invention discloses, in certain aspects, interior pane systems with a frame unit and a pane unit connected to the frame unit, the frame unit connectable to a window that has an exterior pane, the pane unit having an interior pane. The present invention discloses, in certain aspects interior pane systems including: a frame with a frame opening; a pane mount secured to or integral with the frame, a first part of the pane mount in the frame; and the pane mount suitable for holding a pane; and, in one aspect, such a unit with pane in the pane mount. In such a unit, in certain aspects, one of the frame and the pane mount has at least one tongue on a side and the other of the frame and the pane mount has at least one channel on a corresponding side, the at least one tongue releasably receivable within the at least one channel.

Accordingly, the present invention includes features and advantages which are believed to enable it to advance interior pane technology, shutter unit technology, and window unit technology. Characteristics and advantages of the present invention described above and additional features and benefits will be readily apparent to those skilled in the art upon consideration of the following detailed description of preferred embodiments and referring to the accompanying drawings.

Certain embodiments of this invention are not limited to any particular individual feature disclosed here, but include combinations of them distinguished from the prior art in their structures, functions, and/or results achieved. Features of the invention have been broadly described so that the detailed descriptions of embodiments preferred at the time of filing for this patent that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

What follows are some of, but not all, the objects of this invention. In addition to the specific objects stated below for at least certain embodiments of the invention, other objects and purposes will be readily apparent to one of skill in this art who has the benefit of this invention's teachings and disclosures. It is, therefore, an object of at least certain embodiments of the present invention to provide new, useful, unique, efficient, nonobvious systems with an interior pane, structures with an interior pane, windows with an interior pane, connection members, and shutter units with an interior pane.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, various purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly, from a cursory inspection or review to know the nature and general area of the disclosure of this invention. The Abstract is neither intended to define the invention, which is done by the claims, nor is it intended to be limiting of the scope of the invention or of the claims in any way.

It will be understood that each of and the various embodiments of the present invention may include one, some, or all of the disclosed, described, and/or enumerated aspects, improvements and/or technical advantages and/or any or some, in any possible combination, of an element or elements in claims to this invention.

Certain aspects, certain embodiments, and certain preferable features of the invention are set out herein. Any combination of aspects or features shown in any aspect or embodiment can be used except where such aspects or features are mutually exclusive.

### BRIEF DESCRIPTION OF THE SEVERAL VIEWS OF THE DRAWINGS

A more particular description of embodiments of the invention briefly summarized above may be had by references to the embodiments which are shown in the drawings which form a part of this specification. These drawings illustrate embodiments preferred at the time of filing for this patent and are not to be used to improperly limit the scope of the invention which may have other equally effective or legally equivalent embodiments.

FIG. 1A is a perspective view of a unit according to the present invention.

FIG. 1B is a rear view of the unit of FIG. 1A.

FIG. 1C is a perspective view of the unit of FIG. 1A with a louver part open.

FIG. 1D is a top perspective view of the unit of FIG. 1A with a louver part open.

FIG. 1E is a rear view of the unit of FIG. 1A.

FIG. 1F is a rear view of the unit of FIG. 1A.

FIG. 1G is a top view of part of the unit of FIG. 1A.

FIG. 1H is a front view of the unit of FIG. 1A with the louver part unconnected.

FIG. 2A is a top view of parts of the unit of FIG. 1A.

FIG. 2B is a top view of parts of the unit as shown in FIG. 2A with the parts together.

FIG. 3A is a top view of a metal strip of the unit of FIG. 1A.

FIG. 3B is a top view of a magnetic strip of the unit of FIG. 1A.

FIG. 4 is a cross-section view of a prior art connection member for a shutter unit.

FIG. 5 is a cross-section view of a shutter unit according to the present invention.

FIG. 5A is a cross-section view of a shutter unit according to the present invention.

FIG. 5B is a cross-section view of a unit according to the present invention.

FIG. 6 is a cross-section view of a shutter unit according to the present invention.

FIG. 7A is a top view of a connection member for a shutter unit according to the present invention.

FIG. 7B is a cross-section view of the member of FIG. 7A.

FIG. 7C is a top view of a pane holder according to the present invention.

FIG. 7D is a top view of a pane mount according to the present invention.

FIG. 8A is a cross-section view of a connection member for a shutter unit according to the present invention.

FIG. 8B is a front view of part of a unit according to the present invention.

FIG. 8C is a front view of a part of a unit according to the present invention.

FIG. 9A is a perspective view of a shutter according to the present invention.

FIG. 9B is a cross-section view of the shutter unit of FIG. 9A.

FIG. 10 is a perspective view of a shutter unit according to the present invention.

FIG. 11A is a top view of a shutter body according to the present invention.

FIG. 11B is a top view of a shutter body of the shutter unit of FIG. 11A.

FIG. 12 is a top view of a shutter body according to the present invention.

FIG. 13 is a top view of a shutter body according to the present invention.

FIG. 14A is a top view of a shutter body according to the present invention.

FIG. 14B is a top view of a pane of the shutter unit of FIG. 14A.

FIG. 15 is a top view of a shutter body according to the present invention.

FIG. 16A is a top view of a shutter body according to the present invention.

FIG. 16B is a top view of a pane of the shutter unit of FIG. 16A.

FIG. 16C is a top view of a shutter body of the shutter unit of FIG. 16A.

FIG. 16D is a side view of the pane of FIG. 16B.

FIG. 17A is a top view of a shutter body according to the present invention.

FIG. 17B is a top view of a pane of the shutter unit of FIG. 17A.

FIG. 17C is a side view of a shutter body of the shutter unit of FIG. 17A.

FIG. 17D is a side view of the pane of FIG. 17A.

FIG. 18 is a top view of a shutter unit according to the present invention.

FIG. 19A is a top view of a window unit according to the present invention.

FIG. 19B is an enlarged view of part the window unit of FIG. 19A.

FIG. 19C is a partial cross section view of part of the window unit of FIG. 19A.

FIG. 19D is an end view of the window unit of FIG. 19A.

FIG. 19E is an enlarged view of part of the window unit as shown in FIG. 19D.

FIG. 19F is an end view of the window unit as shown in FIG. 19D with a pane unit being moved.

FIG. 20A is a perspective view of a pane unit according to the present invention.

FIG. 20B is a top view of the pane unit of FIG. 20A.

FIG. 21 shows in cross-section shapes for tongues and channels for a pane unit according to the present invention.

FIG. 22A is a rear view of a frame unit according to the present invention with a pane unit according to the present invention.

FIG. 22B is a cross-section view of the units of FIG. 22A

FIG. 22C is a rear view of the frame unit of FIG. 22A.

FIG. 22D is a rear view of the pane unit of FIG. 22A.

FIG. 23 is a rear view of a frame unit according to the present invention with a pane unit according to the present invention with a blind.

FIG. 24 is a rear view of a frame unit according to the present invention with a pane unit according to the present invention with a shade.

FIG. 25 is a rear view of a frame unit according to the present invention with a pane unit according to the present invention with a shutter unit.

FIG. 26A is a perspective view of a frame unit with a pane unit according to the present invention.

FIG. 26B is a perspective view of part of the frame unit of FIG. 26A.

FIG. 26C is a perspective view of the pane unit of FIG. 26A.

FIG. 26D is a perspective view, partially schematic, of a frame unit according to the present invention with a window.

FIG. 26E is a perspective view of a frame unit with a pane unit according to the present invention.

FIG. 26F is a cross-section view of part of a frame unit according to the present invention.

FIG. 26G is a cross-section view of part of a frame unit with a pane according to the present invention.

FIG. 26H is a cross-section view of part of a frame unit with a pane according to the present invention.

FIG. 27 is a perspective view of a frame unit according to the present invention.

FIG. 28 is an end view of a part of a frame unit according to the present invention.

FIG. 29 is a top view of a part of a unit according to the present invention.

FIG. 30 is a perspective view of part of a frame unit according to the present invention.

FIG. 31 is a perspective view of part of a frame unit according to the present invention.

Certain embodiments of the invention are shown in the above-identified figures and described in detail below. Various aspects and features of embodiments of the invention are described below and some are set out in the dependent claims. Any combination of aspects and/or features described below or shown in the dependent claims can be used except where such aspects and/or features are mutually exclusive. It should be understood that the appended drawings and description herein are of certain embodiments and are not intended to limit the invention or the appended claims. On the contrary, the intention is to cover all modifications, equivalents and alternatives falling within the spirit and scope of the invention as defined by the appended claims. In showing and describing these embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiments, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory, any aspect or feature or combination of aspects or features of any embodiment disclosed herein may be used in any other embodiment disclosed herein.

### DETAILED DESCRIPTION OF THE INVENTION

### Preferred Embodiments at Time of Filing for this Patent

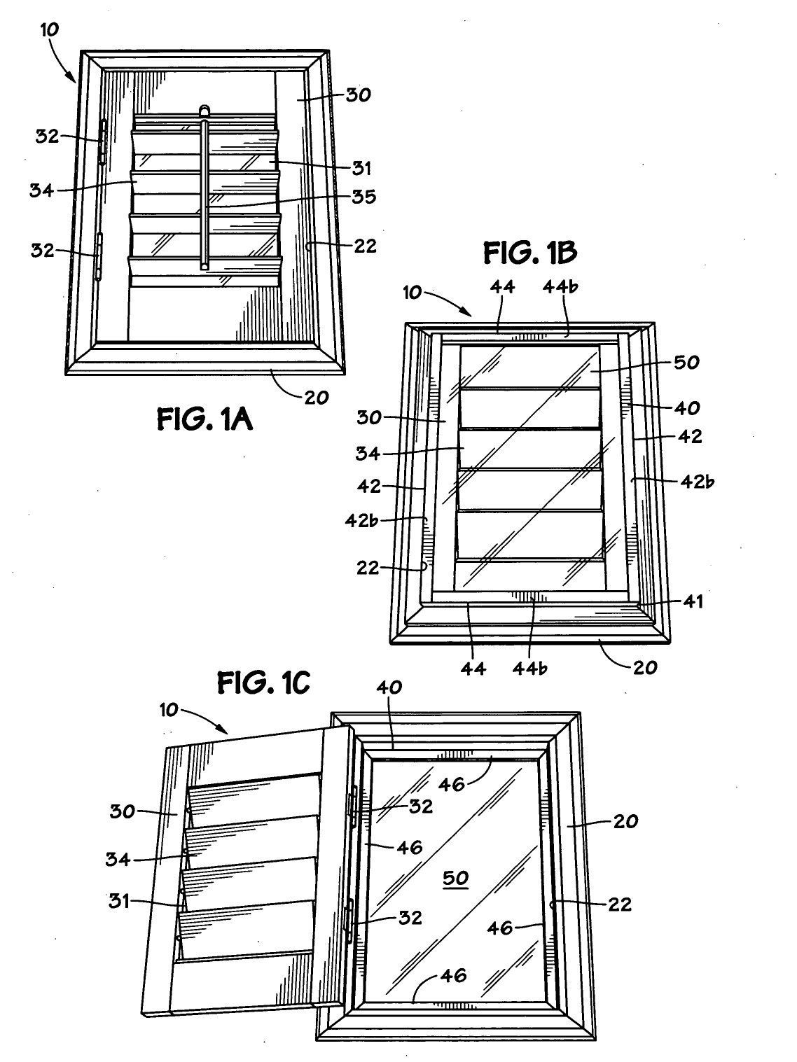

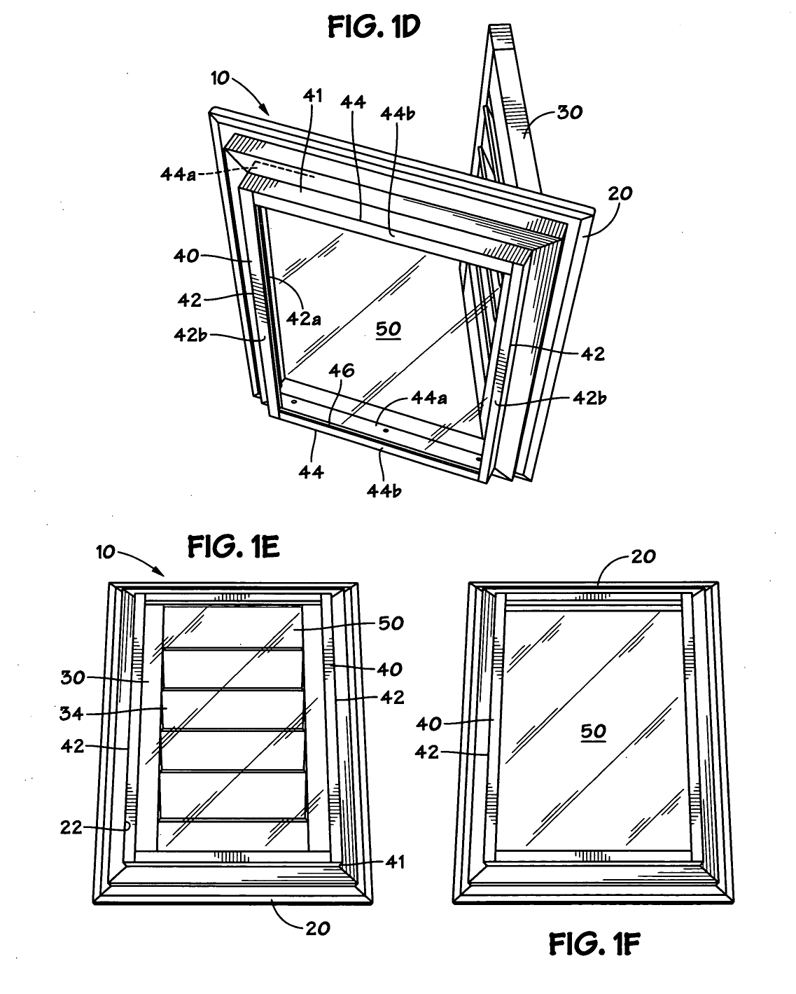

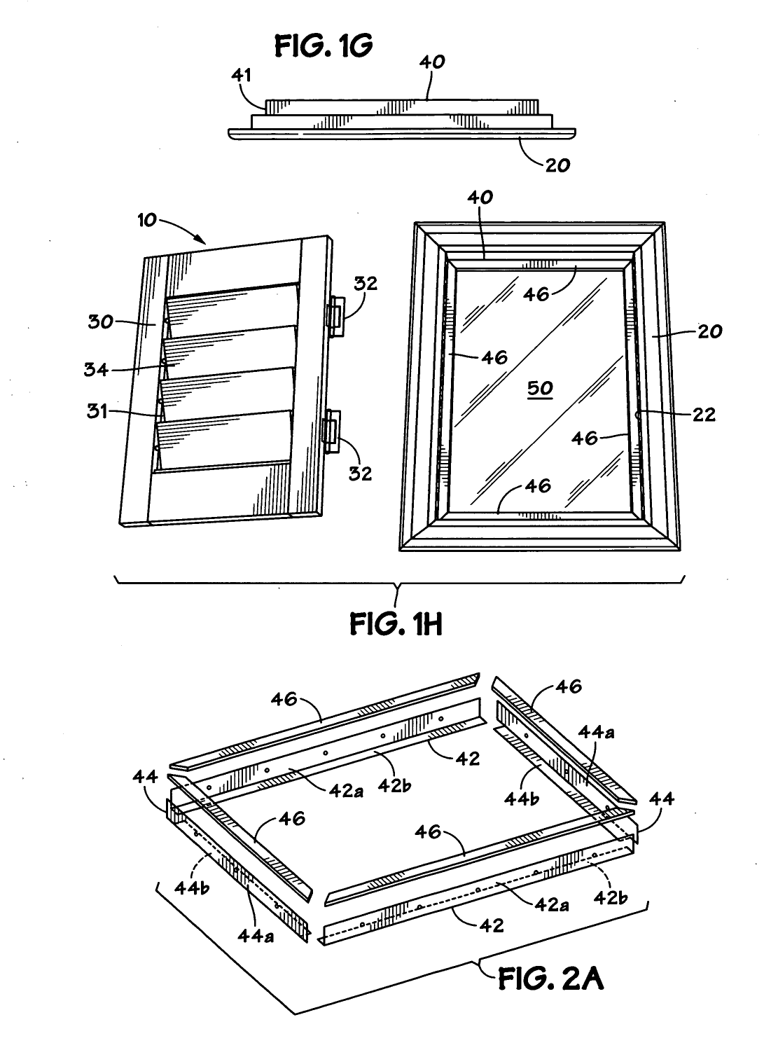

Referring now to FIGS. 1A-1D, a shutter unit 10 according to the present invention has a frame 20, a shutter 30, a pane mount 40, and a pane 50. The shutter 30 is hingedly connected to the frame 20 with hinges 32 and has louvers 34 movably connected in an opening 31 of the shutter 30. The louvers 34 are moved by moving a bar 35 connected movably to each louver 34. Optionally, in certain window units according to the present invention, the louvers are deleted. It is to be understood that the teachings and disclosures of this invention are applicable to interior units that do not have louvers, i.e., although some interior shutter units are disclosed herein in detail, it is within the scope of the present invention to delete the louvers from any embodiment hereof and thereby provide an interior unit (e.g., a window unit for use with a curtain, blind or blinds, a shade or shades, or a window cover. Also, an interior unit may, according to the present invention, with louvers deleted, have any structure disclosed herein for adding an interior pane to an exterior window unit.

The pane mount 40 (made of metal) is secured in an opening 22 of the frame 20. Part 41 of the pane mount 40 projects out from the rear of the frame 20. Sides 42 of the pane mount 40 have first portions 42a that abut sides of the frame opening 22 and are secured thereto, e.g. with adhesive, screws or nails. The sides 42 also have second portions 42b at right angles to the first portions 42a. Ends 44 of the pane mount 40 have first portions 44a that abut ends of the frame opening 22 and are secured thereto, e.g. with adhesive, screws or nails. The ends 44 also have second portions 44b at right angles to the first portions 44a.

Magnetic strips 46, magnetically attracted to the pane mount 40, hold the pane 50 in place (see, e.g., FIG. 1C; edges of the pane shown in dotted line under the magnetic strips 46).

FIG. 4 shows a prior art connection member CM used in a prior art shutter unit to connect it to a wall around a window opening.

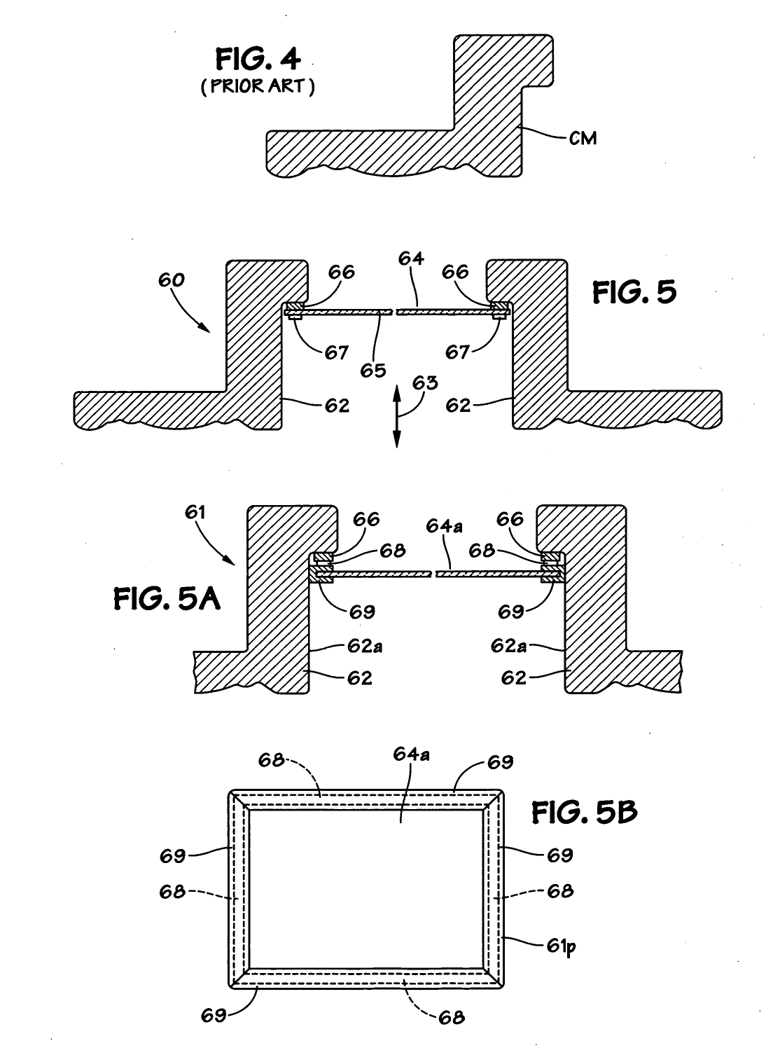

FIG. 5 shows a shutter unit 60 according to the present invention (partially) with a frame (like the frame 20, FIG. 1A) having sides with connection members 62 for securement to a wall around a window opening. Each connection member 62 is of sufficient extent that it has a space 63 for louver movement (louvers not shown) and an area 64 for a pane 65. The pane 65 is mounted to the connection members using metal strips 66 secured to the connection members 62 and magnetic strips 67 magnetically holding the pane 65 in place. Optionally, and as is true for any unit according to the present invention, a pane may be held in place by adhesive against a pane mount made of any suit material, including, but not limited to metal, wood, plastic, etc. and/or by members connected to and/or adhered to the frame adjacent the pane. Optionally, the louvers are deleted.

FIG. 5A shows a unit 61 according to the present invention, (like the unit 60, FIG. 5; like numerals indicate like parts) with a pane structure 61p which has a pane 64a encompassed by holders 69 which have magnets 68 magnetically and releasably held to the metal strips 66. The holders 69 may be a plastic extrusion to which the magnets 68 are connected and/or adhered. In one aspect the holders 69 sealingly abut interior surfaces 62a which extend all around the opening of the unit (like the opening 31, FIG. 1A). The magnets 68 can sealingly contact the strips 66 and the strips 66 can extend all around the opening as can the magnets 68.

FIG. 5B shows the pane structure 61p. With a shutter with louvers (not shown), the structure 61p would be a shutter unit according to the present invention.

As with any unit (pane unit, shutter unit or window unit) and pane according to the present invention, the pane 65 may be clear glass, acrylic, or plastic, translucent material, opaque material, material that allows light of all colors to pass therethrough, or material that allows only light of one or of certain colors to pass therethrough.

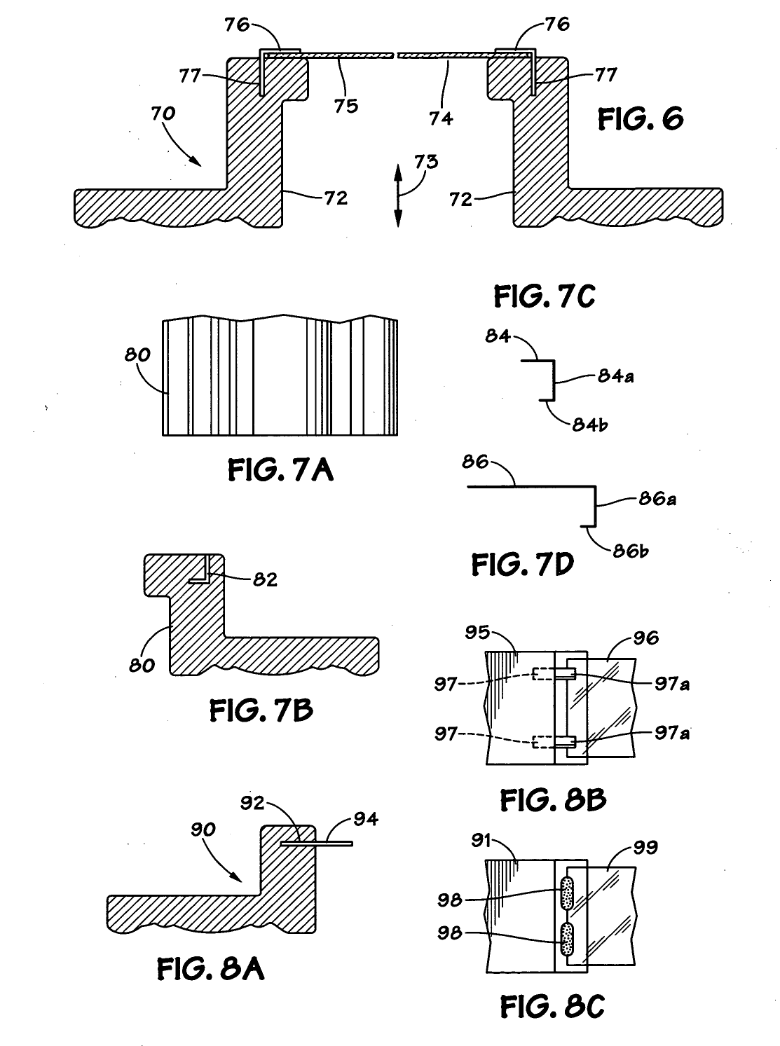

FIG. 6 shows a shutter unit 70 according to the present invention (partially) with a frame (like the frame 20, FIG. 1A) having sides with connection members 72 for securement to a wall around a window opening. Each connection member 72 is of sufficient extent that it has a space 73 for louver movement (louvers not shown) and an area 74 for a pane 75 mounted to the connection members 72 using metal holders 76 secured in grooves 77 of the connection members 72 which hold the pane in place with a friction fit and/or with adhesive. Optionally the holders 76 are secured in place with adhesive. Optionally, e.g., in a window unit according to the present invention, the louvers are deleted.

As is true for any unit according to the present invention, the unit can be used to add an interior pane adjacent an exterior window and any and all louvers and/or shutter(s) may be deleted.

FIGS. 7A and 7B show a unit connection member 80 according to the present invention which has a groove 82 for holding part (84a, 84b) of a holder 84, FIG. 7C (made, e.g., of metal or plastic). A metal holder 84 functions as does a metal holder 76, FIG. 6; or the groove 82 functions to hold a part (86a, 86b) of a pane mount side or end 86, FIG. 7D, which is used with a pane mount like the pane mount 40, FIG. 1A.

FIG. 8A shows a connection member 90 according to the present invention for use with a unit according to the present invention which has a groove 92 for holding a pane 94. Alternatively, the groove 92 holds a mount strip which projects partially from the groove 92 and serves as a backing against which a pane is held by a member or by a magnetic strip (when the mount strip is metal).

FIG. 8B illustrates that a pane in a unit according to the present invention can be held in place by a suitable member that projects sufficiently from a frame side to hold a pane in place. As shown in FIG. 8B, plugs 97 have heads 97a that project from a side 95 of a frame and prevent a pane 96 from falling out of the frame with the side 95.

FIG. 8C illustrates that a pane in a unit according to the present invention can be held in place by a tape (or multiple pieces of tape) that tape the pane in place. As shown in FIG. 8C, pieces of tape 98 in contact with part of a pane 99 and with part of a frame 91 hold the pane 99 in place.

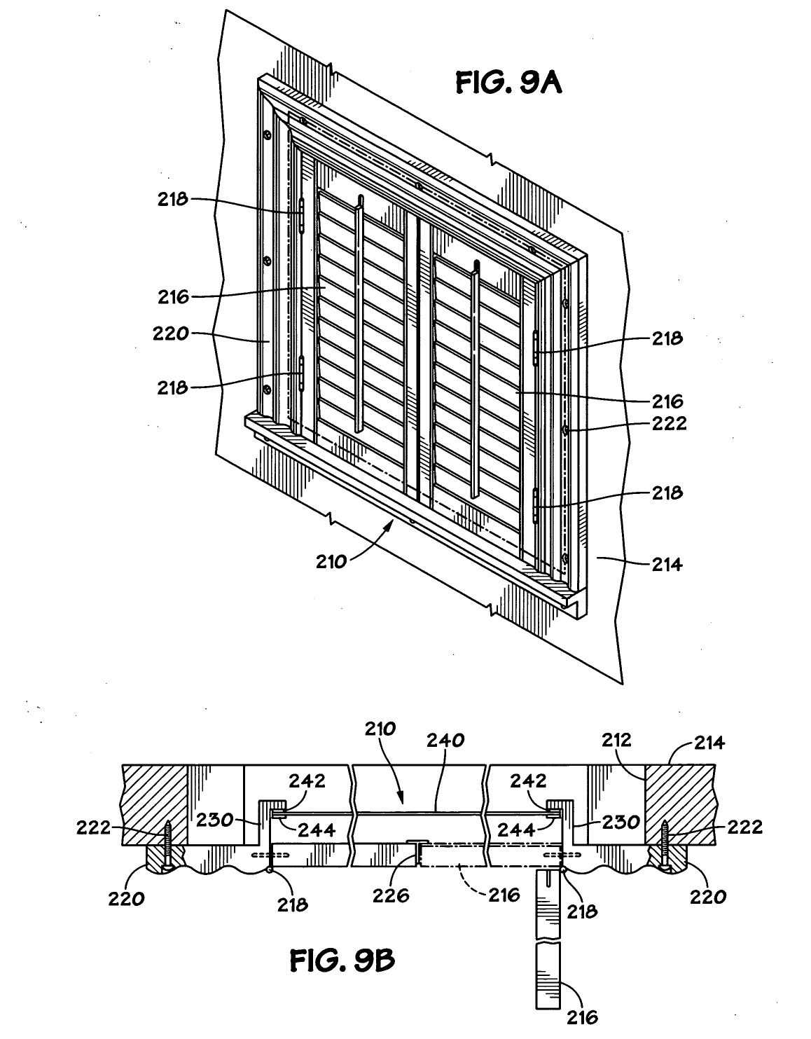

FIGS. 9A and 9B illustrate an improvement of the unit disclosed in U.S. Pat. No. 6,865,846 which is incorporated fully herein by reference for all purposes. FIGS. 9A and 9B show a shutter unit 210 according to the present invention mounted in an opening 212 in a wall 214. Shutters 216 are hingedly connected with hinges 218 to connection members 220. Screws 222 secure the connection members 220 to the wall 214. A stop 226 abuts the shutters 216 when they are closed (one shutter 216 shown open in FIG. 9B).

A pane 240 is held against metal strips 242 by magnetic strips 244.

In any unit according to the present invention when only a magnetic member or magnetic members and/or metal part(s) are used to hold a pane in place, the pane is easily removed by first removing the magnetic members. Magnetic strips according to the present invention may, as shown in some of the drawings, be substantially as long as their corresponding metal strips; or they may be only so long as is needed to hold a pane in place. Similarly, the metal strips need not extend for the entire length of a frame's opening and need be only so long as is needed to hold a pane in place. Optionally, for any unit according to the present invention, structure to hold a pane in place and/or tongue/channel structures may be used only on a frame side or a frame's sides or only on a frame's end or ends.

Using a magnetic strip pane mount or tape (or both) to hold a pane in place, in certain embodiments of the present invention the entire periphery of a pane is covered, either by portions of the magnetic strips or by tape, so that the entire periphery is sealed to air flow.

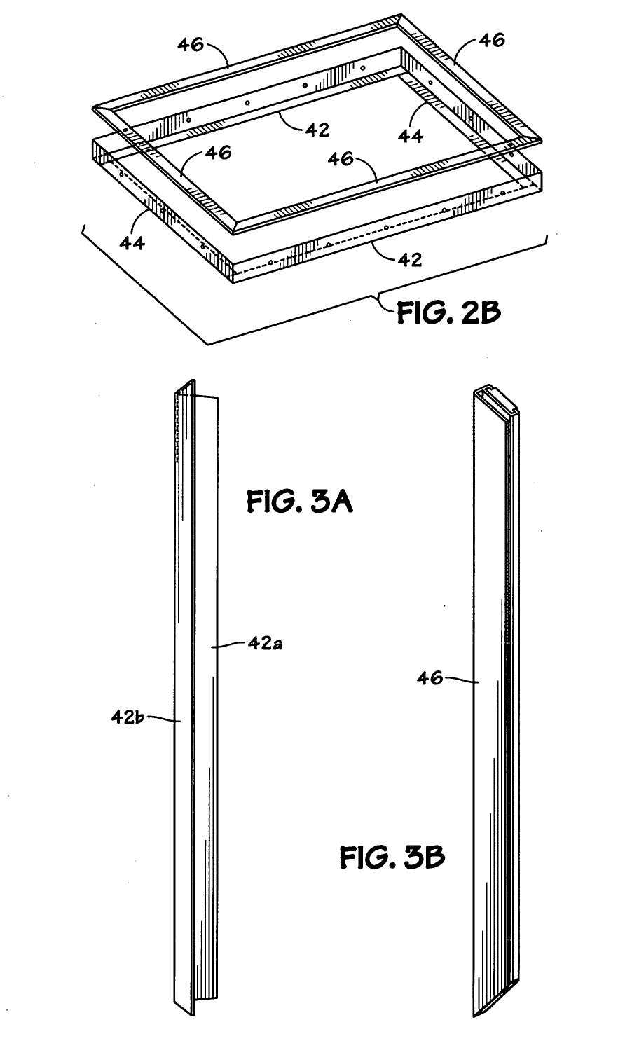

It is within the scope of the present invention to provide a shutter (e.g., but not limited to the shutter 30, FIG. 1A; or a shutter 216, FIG. 9A) with a pane attached, adhered, and/or connected to a shutter instead of or in addition to, a pane of a shutter unit (e.g., but not limited to, a pane as in any of FIGS. 1A-9B).

FIG. 10 shows a shutter unit 10a (like the shutter unit 10, FIG. 1A; and like numerals indicate like parts) with a pane 300 connected to a shutter 30a (like the shutter 30, FIG. 1A) with bolts 301 and nuts 302. The bolts 301 are sufficiently long that movement of the louvers 34 is not impeded. Optionally, the pane 50 is deleted; and optionally, in a unit according to the present invention, the louvers are removed. Optionally, instead of the louvers, a solid member (opaque, transparent, or translucent) covers the opening through the shutter (which can be done to any shutter unit disclosed herein to make a unit according to the present invention without louvers).

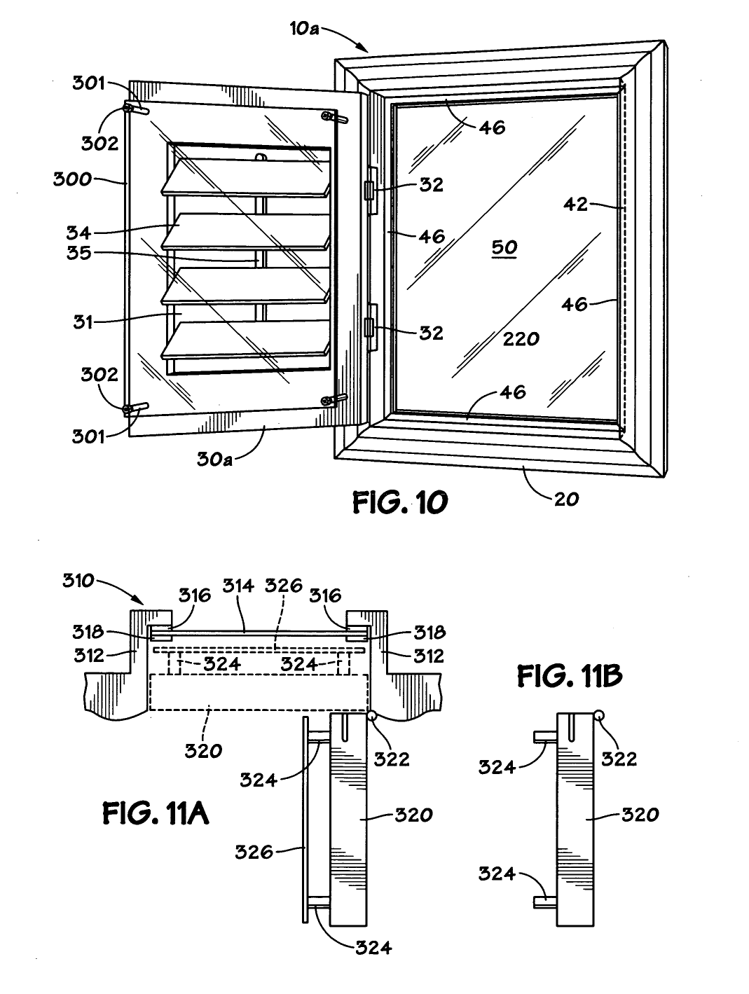

FIG. 11A shows a shutter unit 310 according to the present invention with sides 312 to which an optional pane 314 is magnetically connected using strips 316 and magnets 318. A shutter 320 is hingedly connected with a hinge 322 to a side 312. Blocks 324 are secured to the shutter 320 (like any shutter disclosed or described herein with any louvers described or disclosed herein, but with louvers not shown for clarity). A pane 326 is connected, secured and/or adhered to the blocks 324. As shown in FIG. 11A, the pane 326 may be positioned spaced-apart from the pane 314. In one aspect, edges of the pane 326 sealingly abut interior surfaces of the sides 312. In one aspect, the pane 326 fills an interior space defined by interior surfaces of sides and ends of the shutter unit. Dotted lines in FIG. 11A indicate the closed position of the shutter 320.

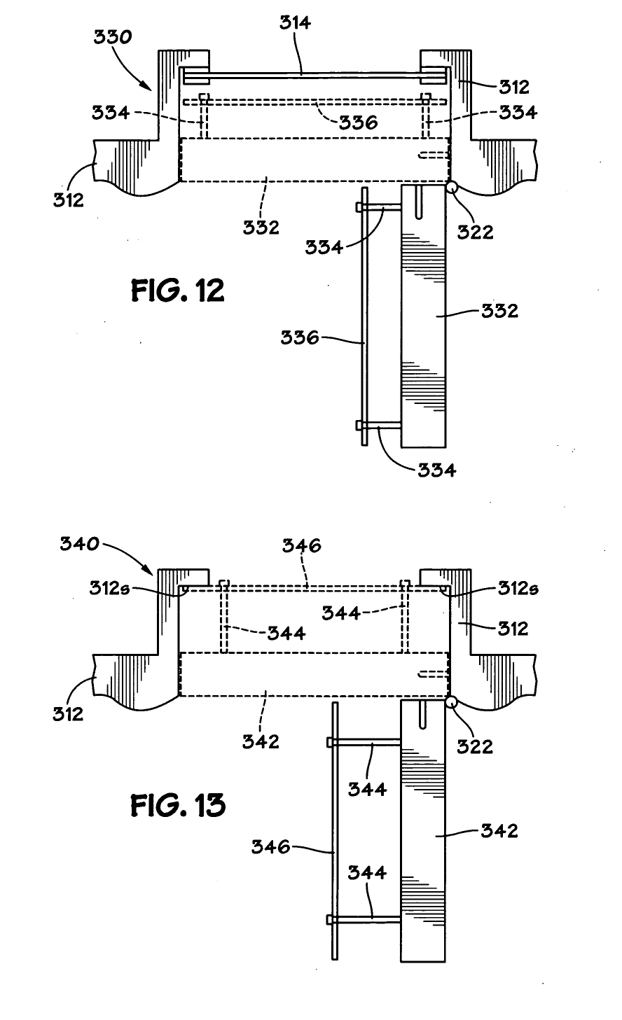

FIG. 12 shows a shutter unit 330 (like the shutter unit of FIG. 11A and like numerals indicate like parts). The shutter unit 330 has a shutter 332 with studs 334 projecting therefrom. A pane 336 has holes 338 which receive the studs 334. Any suitable adhesive, glue, nut, lock ring, etc. can be used to secure the pane 336 to the studs 334, and/or a friction fit therebetween may be employed.

FIG. 13 illustrates a shutter unit 340 according to the present invention (like the units of FIGS. 11A and 12, and like numerals indicate like parts). The shutter unit 340 has a shutter 342 with studs 344 to which a pane 356 is connected. As shown in dotted lines, the pane 346 sealingly abuts surfaces 312s of the sides 312 and the pane 314 with the strips and magnets 318 have been deleted. As is true of any shutter in any of FIGS. 11A-18 no louvers are shown, but any of these shutters has one, at least one, or a plurality of movable louvers, e.g. as the louvers in FIG. 1A of FIG. 9A.

In any of the shutter units of FIG. 10, FIG. 11A, FIG. 12, FIG. 13, or FIG. 18 and in any shutter unit according to the present invention, one, two, three, four, or more bolts, studs, pins, and/or blocks may be used to provide connecting structure to connect a pane to a shutter.

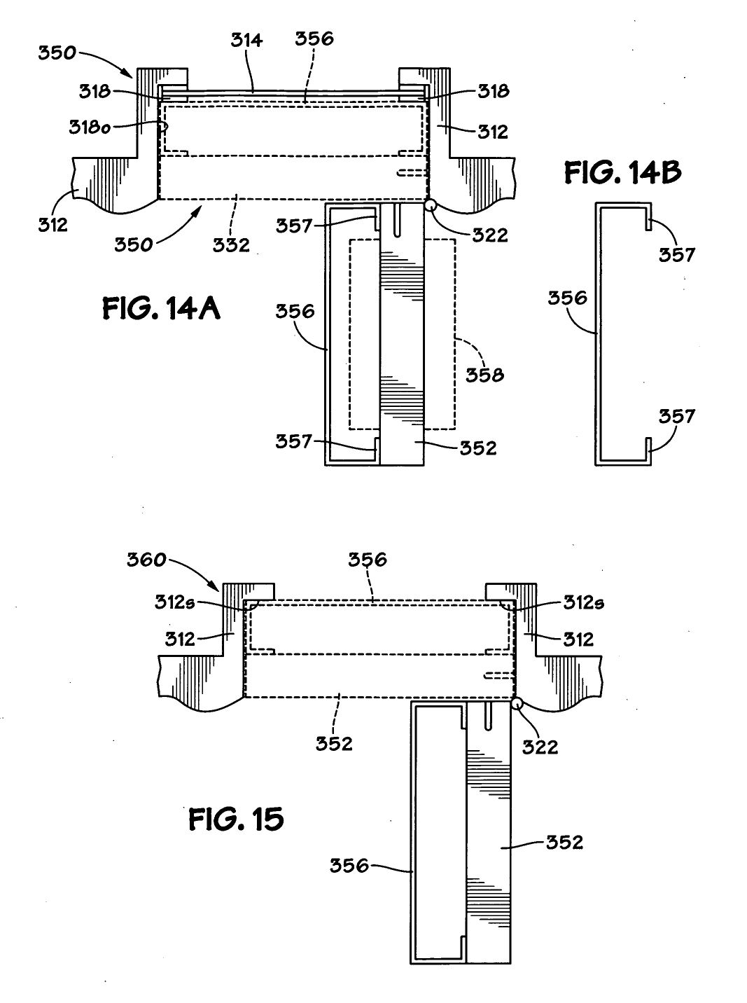

FIG. 14A shows a shutter unit 350 according to the present invention (like the shutter unit of FIG. 11A and like numerals indicate like parts). A shutter 352 has a pane 356 secured to the shutter 352 with any appropriate adhesive, glue, cement, and/or connecting material (e.g., hook-and-loop releasably cooperating fastener material or other releasably cooperating fastener material). Parts 357 of the pane 356 are adhered to the shutter 352.

As with other shutters with panes according to the present invention, the pane 356 is sized so that louver(s) on the shutter 352 are movable and their movement is not impeded by the pane. This is illustrated by a louver 358 shown in dotted line in FIG. 14A.

As shown in FIG. 14A, the pane 356 sealingly abuts the magnets 318. In one aspect, the magnets 318 extend around the entire periphery of an opening 318o defined by the sides 312 and a top and a bottom (not shown) of the shutter unit; and thus the pane 314 seals off this opening. The pane 356 also seals off this opening since it sealingly abuts the magnets 318.

FIG. 15 shows a shutter unit 360, like the shutter unit 350 (like numerals indicate like parts), but with no pane 314. The pane 356 sealingly abuts surfaces 312s of the sides 312 and surfaces of a top and bottom (not shown).

It is within the scope of the present invention to connect a pane to a shutter by providing a slot or slots in the shutter which releasably receive and hold part of a pane. With panes that are sufficiently flexible, a pane can be flexed and positioned so that parts of the pane, upon release, go into the slot(s). In other aspects, part of a pane is pushed into a slot. Optionally, slot(s) are located so that a pane can be pushed down (or up) into the slot(s).

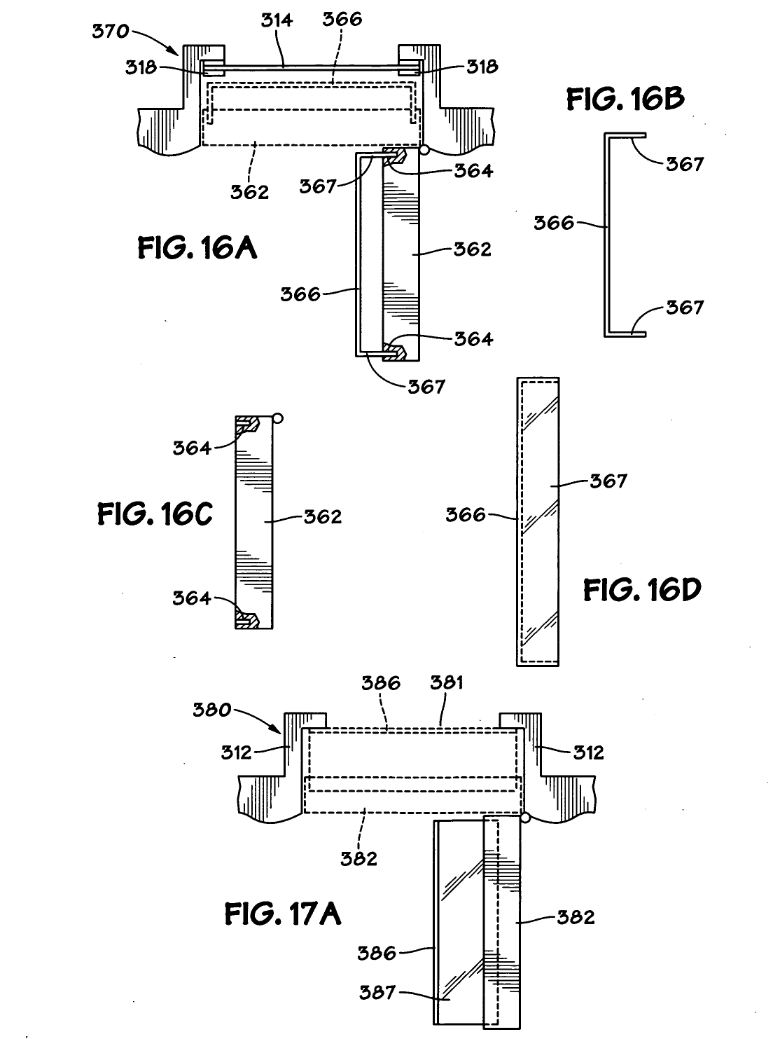

FIG. 16A shows a shutter unit 370 according to the present invention (like the unit of FIG. 11A; like numerals indicate like parts). The shutter unit 360 has a shutter 362 with a pane 366. End portions 367 of the pane 366 are received in and held in slots 364 of the shutter 362. As shown in FIG. 16A, the pane 366 does not contact the magnets 318, but it is within the scope of the present invention for the pane 366 to sealingly contact the magnets 318. Optionally, the pane 314 is deleted.

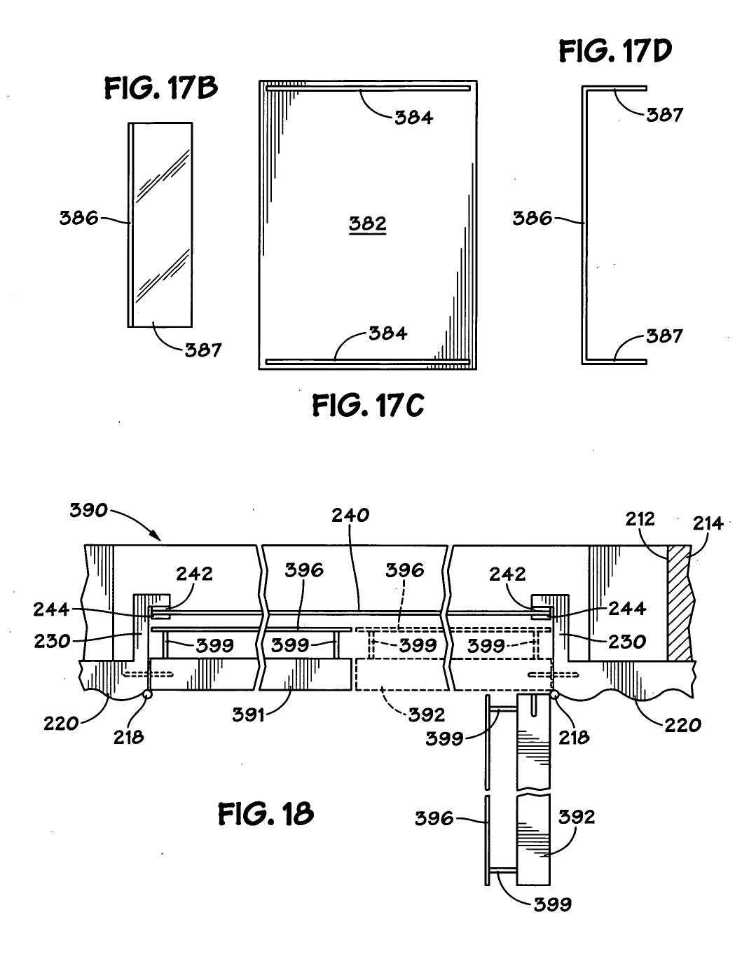

FIG. 17A shows a shutter unit 380 according to the present invention (like the unit of FIG. 16A; like numerals indicate like parts). The shutter unit 380 has a shutter 382 with slots 384 which hold and receive end portions 387 of a pane 386. The pane 386 is sized and configured to abut surfaces of the shutter unit 380 to seal off an opening 381 of the unit. As in FIGS. 11A, 12, 13, 16A, and 18, dotted lines indicate a closed shutter position in FIG. 17A.

FIG. 18 illustrates a shutter unit 390 according to the present invention (like the unit of FIGS. 9A, 9B; like numerals indicate like parts). The shutter unit 390 has shutters 391, 392 each with a pane 396 connected to the shutter with pins 399. The pane 240 may be deleted.

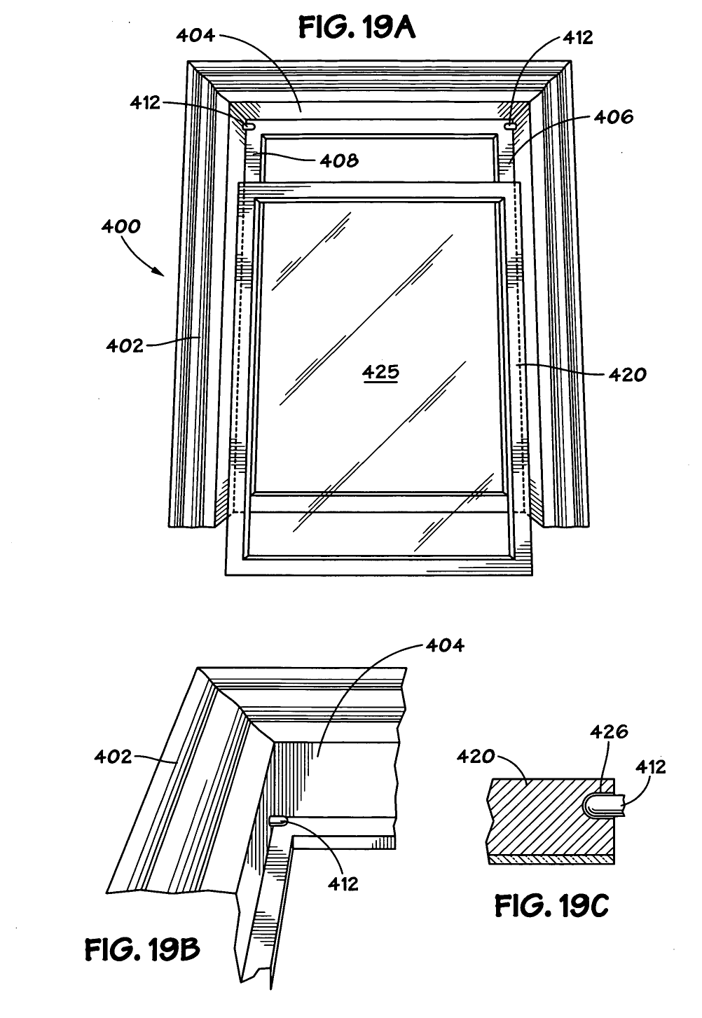

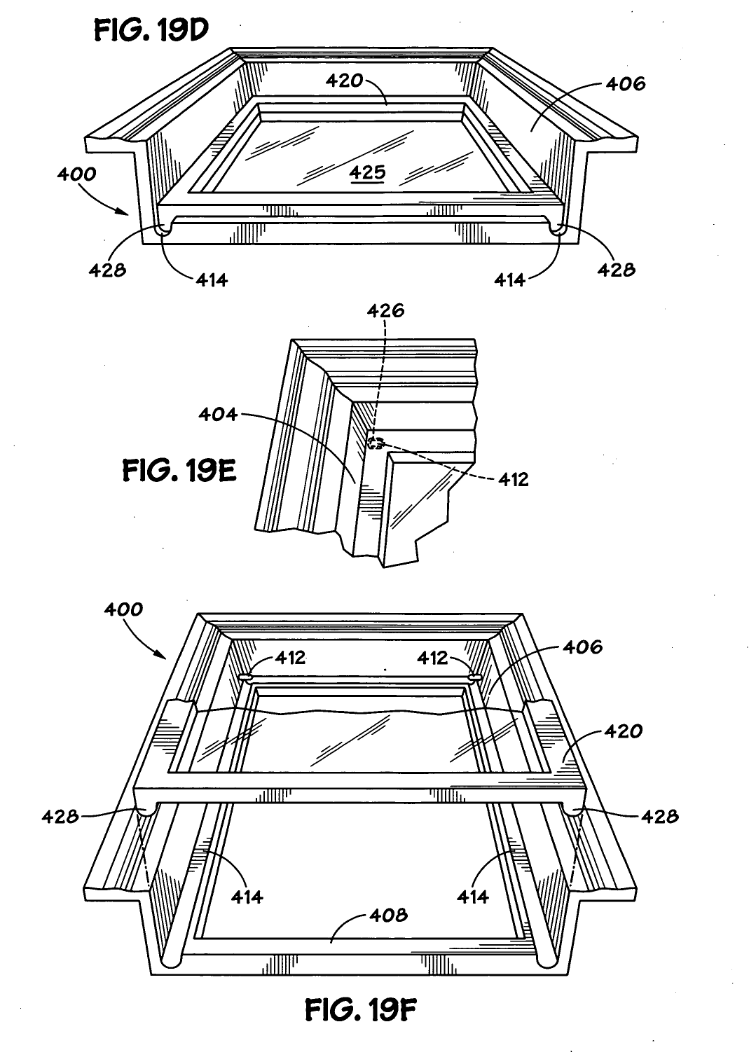

FIGS. 19A-19F show a window unit 400 according to the present invention with a frame 402 and pane unit 420. Such a frame and/or such a pane unit may be used with any structure or window disclosed herein. The frame 402 has an opening 404 for receiving the pane unit 420 and a space 406 with a support 408 for the pane unit 420. Holding rods 412 project from the frame 402 into the space 406 for receipt within corresponding recesses 426 of the pane unit 420.

Optionally, the support 408 (or any desired part thereof) is metal that is attracted to a magnet and the pane unit 420 (or any desired part thereof) is made of one or more magnets, or vice versa, to releasably hold (and, in some aspects, to seal) the pane unit 420 to the support 408. Optionally, to secure the pane unit 420 releasably in place in the frame 402, the pane unit 420 has two recesses 426 (either recess may be deleted) each for receiving a part of a rod 412.

The pane unit 420 may be placed in the space 406 and then moved toward the rods 412 until the rods 412 are received within the recesses 426 (e.g. as shown in FIG. 19D and FIG. 19E), thus holding the pane unit in place.

Optionally, the pane unit 420 (with a pane 425) has a tongue 428 on each of two sides 422 (either tongue may be deleted). The frame 402 may have channels 414 corresponding to and for receiving the tongue(s) 428, e.g. to further stabilize the pane unit in place and/or to provide further sealing contact at the frame/pane-unit interface. Optionally, either or both of the tongue(s) 428 and/or channels 414 are made of seal and/or gasket material.

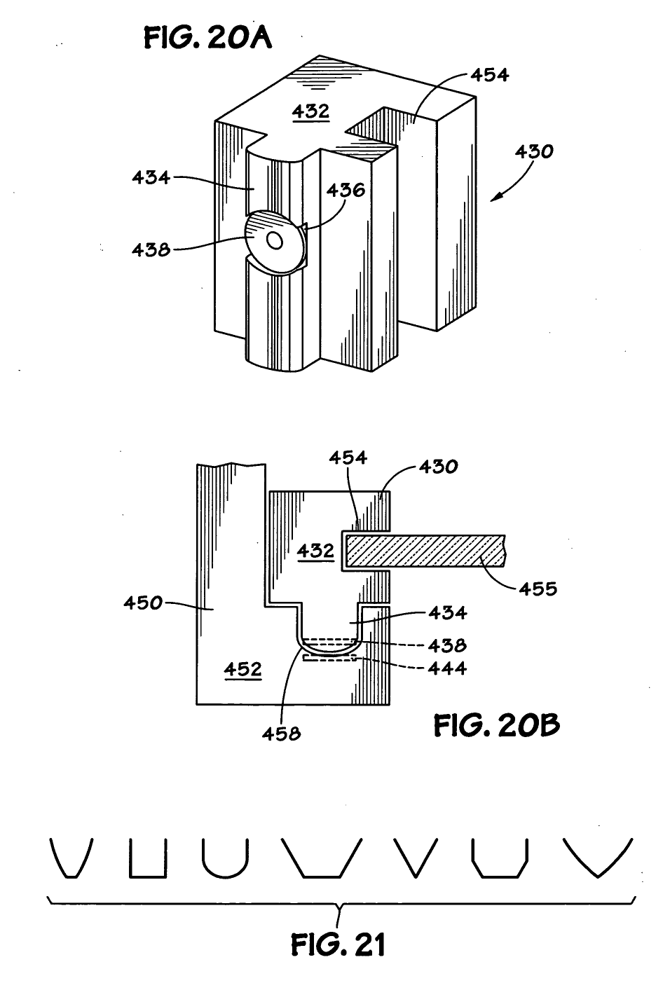

FIGS. 20A and 20B show a part of a pane unit 430 (like the pane unit 420, but the pane unit 430 is only shown partially) which has a body 432 (e.g. a four-sided unit as the pane unit 420, FIGS. 19A, 19D) with tongues 434 (e.g., like the tongues 428). The tongue 434 has a recess 436 with a metal part 438 therein. This metal part 438 is attracted to a magnet 44 (or magnets 444) in a frame 450 according to the present invention shown in FIG. 20B. Optionally, the part 438 (or parts 438—multiple parts 438 may be used with a pane unit according to the present invention) is a magnet which is attracted to and held to the magnet(s) 444 (or instead of magnets 444, metal parts 444 are used).

The frame 450 has a body 452 and grooves 458 (e.g. like the structure shown in FIG. 19D) which corresponds to and receives the tongue(s) 434. Such a frame 450 and/or such a pane unit 430 may be used with any structure, shutter unit, or window unit disclosed herein.

Optionally the tongue(s) 434 are deleted and the parts 438 (or magnets, if used) are in recesses in the body 432 and located for magnetic attraction to the magnet(s) and/or metal parts(s) of a frame.

A slot 454 holds a pane 454 (e.g., but not limited to, a pane of plastic, acrylic or of glass).

Any tongue or channel of any unit or window herein may have any desired shape; including, but not limited to, those shown in FIGS. 19D and 20B and those shown in FIG. 21 (which are cross-sectional views of shapes).

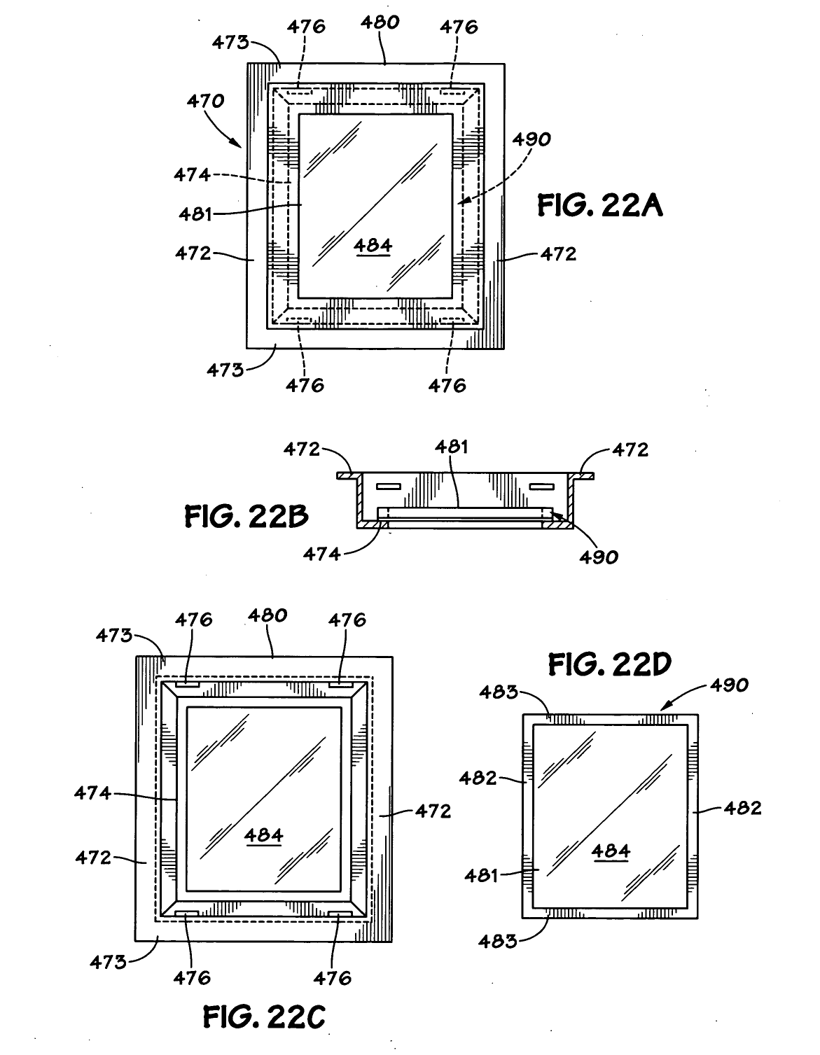

FIGS. 22A-22D show a unit 470 according to the present invention which has a frame unit 480 according to the present invention and a pane unit 490 according to the present invention. The frame unit 470 has sides 472, ends 473, and a pane support 474. Connectors 476 provide for the connection to the frame unit of any suitable known window covering or light blocking structure, e.g., but not limited to, shades, blinds, curtains, drapes, and shutter units. The frame unit may be applied to any suitable known window or window unit, including, but not limited to, any disclosed herein.

The pane unit 480 has sides 482, ends 483, and a pane 484 (which may be like any pane disclosed herein). Any suitable known connector (e.g., screws, rivets, nails, brads, bolts) connection structure, material (e.g. adhesives, glues, caulks, releasably cooperating fastener material) or latch apparatus (e.g., clips, toggles, and/or latches) may be used to connect the pane unit to the frame unit, including, but not limited to, any disclosed herein, including, but not limited to, magnet(s) and metal part(s) and also any of these may be used to connect any window covering herein to any unit herein. The tongue(s) and channel(s) described above may be used with any of the pane units in FIGS. 22A-25.

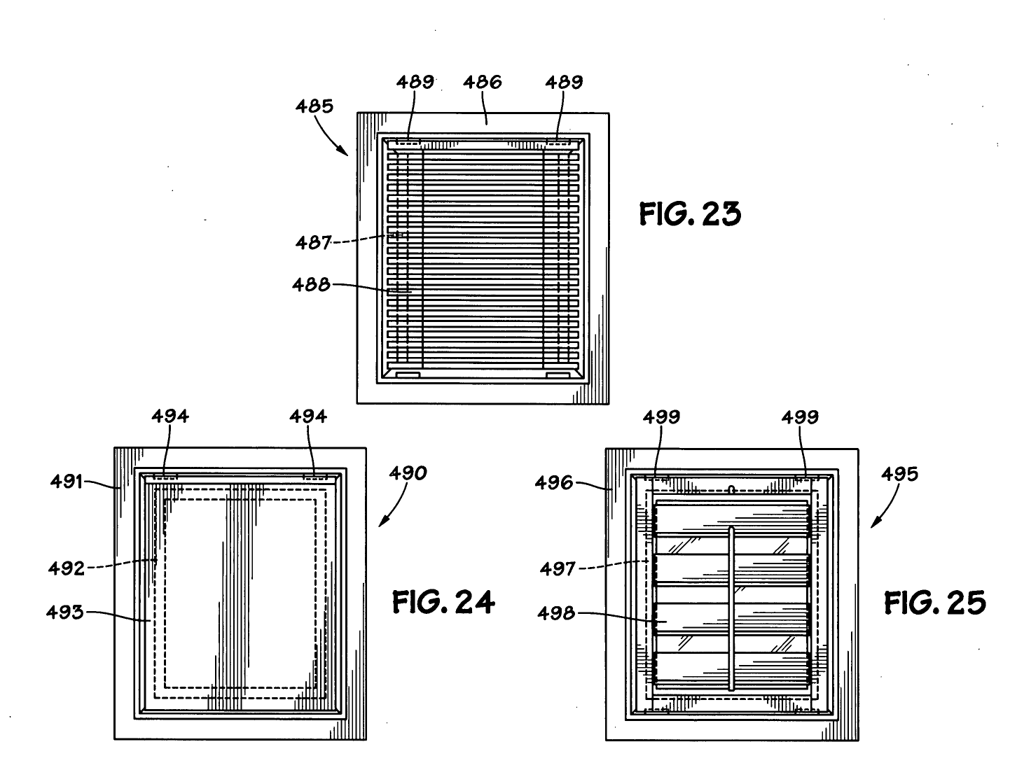

FIG. 23 shows a unit 485 according to the present invention with a frame unit 486 (like the frame unit 470) and a pane unit 487 (like the pane unit 480). A blind 488 is connected to connectors 489.

FIG. 24 shows a unit 490 according to the present invention with a frame unit 491 (like the frame unit 470) and a pane unit 492 (like the pane unit 480). A shade, drape, or curtain 493 is connected to connectors 494.

FIG. 25 shows a unit 495 according to the present invention with a frame unit 496 (like the frame unit 470) and a pane unit 497 (like the pane unit 480). A shutter unit 498 (e.g. any disclosed herein) is connected to connectors 499.

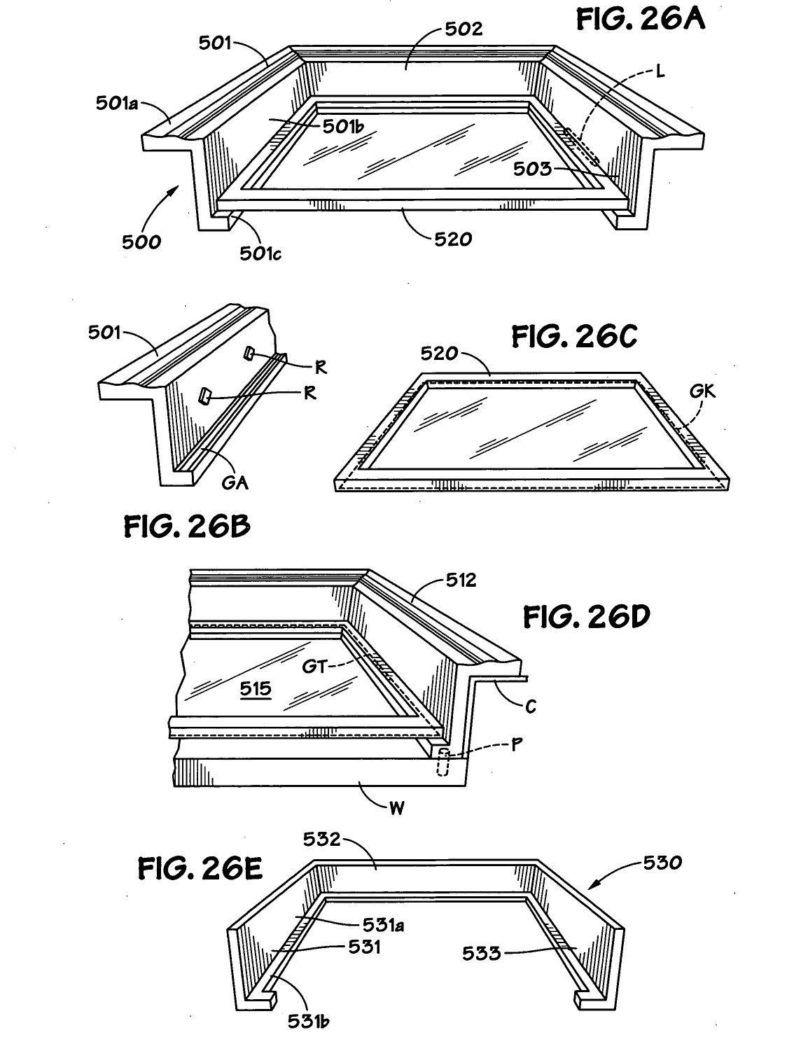

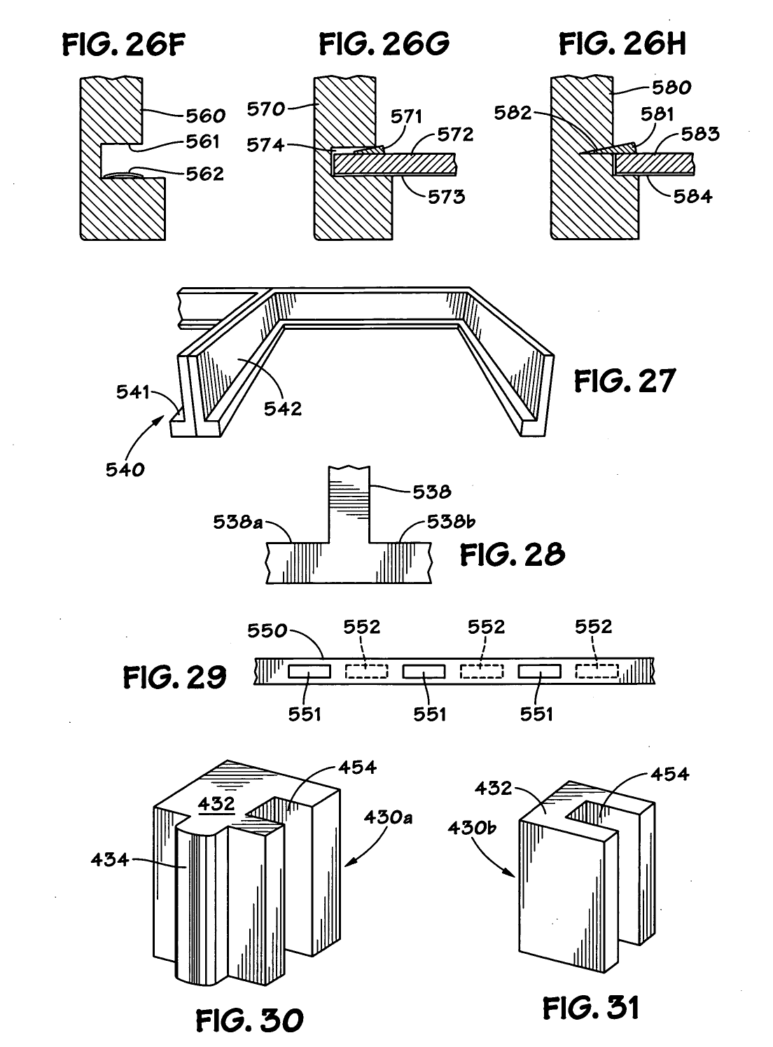

FIG. 26A shows a frame unit 500 according to the present invention with a pane unit 520 installed therein. The frame unit 500 includes three pieces of generally “Z” shaped material (as viewed in cross-section or on end) 501, 502 and 503 which, in one aspect, are custom cut from a single continuous piece of larger material. These pieces are connected together by any suitable structure and/or material, e.g., but not limited to, glue, adhesives, bolts, screws, nails, rivets, Velcro (TRADEMARK) material, releasably cooperating fastener material, or the like.

The “Z” shaped material piece 501 has an optional decorative facing 501a, a side rail 501b, and a pane support 501c. The other pieces, 502 and 503 have the same parts. The pane unit 510 rests on the pane support parts and may be connected thereto by any suitable structure and/or material and/or latch apparatus L (shown in dotted line in FIG. 26A; or multiple apparatuses L located as desired anywhere on the pane unit and/or on the frame unit). Any latch apparatus may be used with any frame herein at any location thereon to releasably connect a frame unit to a window and/or with any pane unit herein to releasably connect a pane unit to a frame unit; for example, see the latch apparatus P, FIG. 26D, for releasably connecting a frame unit to a window.

Optionally, as shown in FIG. 26B, a side part of a frame unit according to the present invention may have one or more connectors R for facilitating connection to the frame unit of another structure such as, but no limited to, window cover(s), a shutter, shade, drape, curtain, or blind. Optionally, such connectors can be connectors supplied with the shutter, etc. Such connectors may be any structure and/or material used for such connection, including, but not limited to, standard mounting hardware and/or connectors.

As is true for any embodiment herein, the pane support parts 501c etc. may be made of magnetic material and/or metal, in whole or in part, that is attracted to magnets, as may be the pane unit 520. The pane unit 514 has pane 515. It is within the scope of the present invention for any pane unit disclosed herein to have any pane disclosed herein.

FIG. 26D shows a frame unit 512, like the frame unit 500, with a window W and a pane unit 514, like the pane unit 520, installed on the frame unit 512. The window has a corner C of an opening of the window W.

FIG. 26E shows a frame unit 530 according to the present invention which has three pieces 531, 532, and 533. These pieces have no decorative facing part (as in, e.g., the frame unit 500). The piece 531 has a side rail 531a and a pane support 531b. The other pieces, 532 and 533, have the same parts.

FIG. 27 illustrates a frame unit 540 which has two frame unit structures 541 (shown partially) and 542, with part of each abutting the other. Such a compound frame unit may be used, e.g., with relatively large windows with a relatively large opening. A pane unit is used with each frame unit.

Optionally, e.g. with relatively large windows, a “T-bar” structure 538 as in FIG. 28 may be used around and/or across an interior opening of a window. Parts 538a and 538b support a pane unit (not shown).

It is within the scope of the present invention to use a magnet, magnets, a piece of metal attracted to a magnet, or such pieces to releasably connect a pane unit to a frame unit and/or a frame unit to a window. The magnet(s) may be on the frame unit with the metal piece or pieces on the window-or vice versa; and/or the magnet(s) may be on the pane unit with the piece or pieces of metal on the frame unit-or vice versa. FIG. 29 illustrates a part 550 which may be a part of a window, of a frame unit, or of a pane unit according to the present invention. Optionally, the part 550 is a magnet or the part 550 is made of metal attracted to a magnet. Optionally, the part 550 has one, two, three or more items 551 thereon, the items being magnets or metal attracted to a magnet; and/or optionally the part 550 has one, two, three or more items 552 therein, the items being magnets or metal attracted to a magnet. In one aspect, the magnet(s) and/or metal parts are sized and located to sealingly connect a frame unit to a window and/or to sealingly connect a pane unit to a frame unit. Optionally, such sealing is achieved with the other connection structures and/or materials referred to above.

FIG. 30 illustrates a shape, in cross-section, for a part 430a of a frame unit according to the present invention, like the part 430, FIG. 20A (like numerals indicate like parts), but without any metal piece or pieces or magnet(s) thereon and/or thereon. FIG. 31 illustrates a shape, in cross-section, for a part 430b of a frame unit according to the present invention, like the part 430a, FIG. 20A but (like numerals indicate like parts), but without any tongue 434 or protrusion therefrom.

It is within the scope of the present invention to use a frame unit that has frame unit pieces on four sides; but it is also within the scope of the present invention to use the frame pieces on only two sides of a window opening (or shutter unit opening) or on only three sides. As shown for example in FIG. 19F, a frame unit according to the present invention may include three sides made from, for example, “Z” shaped or “L” shaped pieces along with a frame support like the frame support part labelled 408 in FIG. 19F. It is also within the scope of the present invention to use flat support surfaces for pane support rather than a channeled surface. Any frame unit disclosed herein may be made with a particular dimension with the knowledge that on site for installation, one or more parts, ends or sides may be cut or shaped as needed to fit a particular window or opening.

The slot or recess in a pane unit for a pane or “glazing” may have any suitable width for glazings of varying thickness. In one aspect, the tolerance of this width is such that, with the glazing in place, air infiltration is inhibited or prevented. Typical thicknesses are between one eight and one fourth of an inch. In certain aspects, the overall thickness of the pane unit is such that it does not interfere with window operation. Glazing may be any suitable product or material, including, but not limited to, plastic, glass, acrylic and other materials that pass applicable building codes.

It is within the scope of this invention to enhance the sealing of a frame-unit/window interface and/or a frame-unit/pane-unit interface by using suitable sealing or gasket material at the interface (on the frame unit, on the pane unit, or on both). For example, as shown in FIG. 26B, gasket material GA is used on the pane support parts of a frame unit; on the pane unit 520 (FIG. 26C), gasket material GK (shown in dotted lines) is used on the bottom surfaces thereof; and/or on the window W, FIG. 26D, gasket material GT (shown in dotted line) is used on the part of the window to contact the frame unit.

Optionally a recess is provided in a frame unit to wedge one edge of a pane unit therein, with or without latch structure, to apply slight pressure to a seal or gasket (e.g., see recess 561 in a frame unit 560 according to the present invention with a gasket 562 on the frame unit, FIG. 26F). Optionally, such a recess has an inclined surface 561s. Optionally, pin(s) are used with a frame unit and a pane unit (or vice-versa), with or without latch apparatus, to apply slight pressure to a seal or gasket (e.g., see the pin 571 in a recess 574 used with the frame unit 570 and pane unit 572 with a gasket 573 in FIG. 26G). Optionally a pin or pins are used with a recess in a frame unit to apply slight pressure to a gasketed pane unit (e.g., see the pin 581 in a recess 582 of a frame unit 580 used with a pane unit 583 that has a gasket 584, FIG. 26H). It is within the scope of the present invention for any pin disclosed herein to be movably connected to a pane unit for movement into a corresponding recess or movably connected to a frame unit.

The present invention, therefore, provides in at least some embodiments, an interior pane system having: a frame unit, a pane unit connected to the unit, the pane unit having a pane, the frame unit applicable to a window, the window having an exterior pane, the window having a window opening, the frame unit sized and configured for positioning at the window opening; in some aspects, such a system including the window; and/or, in some aspects, such a system including a window cover connected to the frame unit.

The present invention, therefore, provides in at least some embodiments, a shutter unit including: a body having a body opening; a shutter movably connected to the body; the shutter movable selectively from a first position to a second position; the shutter in the second position closing off at least part of the body opening; and a pane connected to the shutter and located so that with the shutter in the second position the pane closes off all or at least part of the body opening. Such a shutter unit may have one, or some in any possible combination, of the features, aspects, and/or elements of any shutter unit herein and it may have any pane unit according to the present invention.

The present invention, therefore, provides in at least some embodiments, a shutter unit having: a body, and a shutter movably connected to the body, and a pane connected to the body.

The present invention, therefore, provides in at least some embodiments, a method for sealing an opening in a shutter unit, the shutter unit having a body and a shutter movably connected to the body, the shutter having a pane connected thereto, the pane sized and configured to close off the opening, the method including: moving the shutter with respect to the body to move the pane to the opening so that the pane closes off the opening.

The present invention, therefore, provides in at least some embodiments, a unit which is an interior unit, the unit having: a frame with a frame opening; a pane mount secured to the frame, a first part of the pane mount in the frame opening and a second part of the pane mount projecting out from the frame opening; the pane mount suitable for holding a pane; and, in some aspects, such a unit with at least one shutter movably connected to the frame and/or a pane in the pane mount, the pane mount being any disclosed herein.

The present invention, therefore, provides in at least some embodiments, a shutter unit having: a frame with a frame opening; a pane mount secured to the frame, a first part of the pane mount in the frame opening and a second part of the pane mount projecting out from the frame opening; the pane mount suitable for holding a pane; optionally, a pane in the pane mount; at least one shutter movably connected to the frame; the pane mount having two sides spaced apart by two ends, each side and end comprising a first part and a second part, the second part at a right angle to the first part, the pane abutting the second parts of the sides and ends; the pane mount made of metal; magnetic members abutting the pane and magnetically attracted to the pane mount and holding the pane in place in the pane mount; at least one louver movably connected to the shutter; the at least one louver movable without interfering with the pane mounted in the pane mount.

The present invention, therefore, provides in at least some embodiments, a shutter unit including: a frame with a frame opening; a pane mount secured to the frame; the pane mount suitable for holding a pane.

The present invention, therefore, provides in at least some embodiments, a connection member for connecting a unit to a wall adjacent a wall opening in the wall, the connection member having a body with a front portion for positioning over a part of a wall at the opening, a second portion extending from the front portion, a pane mount secured to the second portion and suitable for holding a pane within the body so that a movable part of the unit is not interfered in movement by the pane. Such a connection member may have a pane in the pane mount and/or any of the other features and/or elements of any connection member disclosed herein.

The present invention, therefore, provides in at least some embodiments, an interior pane unit having: a frame with a frame opening; a pane mount secured to the frame, a first part of the pane mount in the frame; the pane mount suitable for holding a pane; and, in one aspect, a pane in the pane mount. Such a pane mount may be releasably secured to the frame, and/or may have one or some, in any possible combination, of the following: the pane mount being releasably secured to the frame by one of locking mechanism, rod part projecting from the frame into a corresponding recess of the pane mount, a magnet part on one of the frame and pane mount and a metal part on the other of the frame and pane mount to which the magnet part is magnetically attracted to the pane mount to hold a pane in place; a pane connected to the pane mount; and/or wherein one of the frame and the pane mount has at least one tongue and the other of the frame and the pane mount has at least one channel, the at least one tongue releasably receivable within the at least one channel.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. The inventors may rely on the Doctrine of Equivalents to determine and assess the scope of their invention and of the claims that follow as they may pertain to apparatus not materially departing from, but outside of, the literal scope of the invention as set forth in the following claims. All patents and applications identified herein are incorporated fully herein for all purposes. It is the express intention of the applicant not to invoke 35 U.S.C. §112, paragraph 6 for any limitations of any of the claims herein, except for those in which the claim expressly uses the words ‘means for’ together with an associated function. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

What is claimed is:

1. A shutter unit comprising
a body having a body opening,
a shutter movably connected to the body,
the shutter movable selectively from a first position to a second position, the shutter in the second position closing off at least part of the body opening, and
a pane connected to the shutter and located so that with the shutter in the second position the pane closes off at least part of the body opening.

2. The shutter unit of claim 1 wherein the shutter is movable to close off the entire body opening.

3. The shutter unit of claim 1 wherein the pane is movable with the shutter so that the pane closes off the entire body opening.

4. The shutter unit of claim 1 wherein the pane is adhered to the shutter to connect the pane to the shutter.

5. The shutter unit of claim 1 wherein the shutter has at least one slot and wherein the pane is connected to the shutter by inserting part of the pane in the at least one slot.

6. The shutter unit of claim 1 wherein the pane is connected to the shutter with bolts.

7. The shutter unit of claim 1 wherein at least one block projects from the shutter and the pane is connected to the shutter by connecting the pane to the at least one block.

8. The shutter unit of claim 1 wherein two shutters are movably connected to the body and each of the two shutters has a pane connected thereto.

9. The shutter unit of claim 1 further comprising
at least one louver movably connected to the shutter,
the pane located so that the pane does not impede movement of the at least one louver.

10. A shutter unit comprising
a body,
a shutter movably connected to the body,
a pane connected to the shutter.

11. A method for sealing an opening in a shutter unit, the shutter unit having a body and a shutter movably connected to the body, the shutter having a pane connected thereto, the pane sized and configured to close off the opening, the method comprising
moving the shutter with respect to the body to move the pane to the opening so that the pane closes off the opening.

12. A unit comprising an interior unit, the unit further comprising
a frame with a frame opening,
a pane mount secured to the frame, a first part of the pane mount in the frame opening and a second part of the pane mount projecting out from the frame opening,
the pane mount suitable for holding a pane.

13. The unit of claim 12 further comprising
at least one shutter movably connected to the frame.

14. The unit of claim 12 further comprising
a pane in the pane mount,
the pane mount having two sides spaced apart by two ends,
each side and end comprising a first part and a second part, the second part at a right angle to the first part,
the pane abutting the second parts of the sides and ends.

15. The unit of claim 12 further comprising
the pane mount made of metal,
magnetic members for abutting a pane and magnetically attracted to the pane mount to hold a pane in place in the pane mount.

16. The unit of claim 12 further comprising
a pane in the pane mount.

17. The unit of claim 12 further comprising
at least one shutter movably connected to the frame,
at least one louver movably connected to the shutter,
the at least one louver movable without interfering with a pane mounted in the pane mount.

18. The unit of claim 12 wherein the unit is a window unit used with a window structure and the window structure is used with one, at least one of, or a plurality of shade, blind, curtain, cover, shutter.

19. A shutter unit comprising
a frame with a frame opening,
a pane mount secured to the frame, a first part of the pane mount in the frame opening and a second part of the pane mount projecting out from the frame opening,
the pane mount suitable for holding a pane,
a pane in the pane mount,
at least one shutter movably connected to the frame,
the pane mount having two sides spaced apart by two ends,
each side and end comprising a first part and a second part, the second part at a right angle to the first part,
the pane abutting the second parts of the sides and ends,
the pane mount made of metal,
magnetic members abutting the pane and magnetically attracted to the pane mount and holding the pane in place in the pane mount,
at least one louver movably connected to the shutter,
the at least one louver movable without interfering with the pane mounted in the pane mount.

20. A shutter unit comprising
a frame with a frame opening,
a pane mount secured to the frame,
the pane mount suitable for holding a pane.

21. A connection member for connecting a unit to a wall adjacent a wall opening in the wall, the connection member comprising
a body with a front portion for positioning over a part of a wall at the opening,
a second portion extending from the front portion,
a pane mount secured to the second portion and suitable for holding a pane within the body so that a movable part of the unit is not interfered in movement by the pane.

22. The connection member of claim 21 further comprising
a pane in the pane mount.

23. The connection member of claim 21 further comprising
tape holding the pane in the pane mount.

24. The connection member of claim 21 further comprising
a pane in the pane mount,
the pane mount having two sides spaced apart by two ends,
each side and end comprising a first part and a second part, the second part at a right angle to the first part,
the pane positioned on the second parts of the sides and ends.

25. The connection member of claim 21 further comprising
the pane mount made of metal,
magnetic members for abutting a pane and magnetically attracted to the pane mount to hold a pane in place in the pane mount.

26. An interior pane unit comprising
a frame with a frame opening,
a pane mount secured to the frame, a first part of the pane mount in the frame,
the pane mount suitable for holding a pane.

27. The interior pane unit of claim 26 wherein the pane mount is releasably secured to the frame.

28. The interior pane unit of claim 27 wherein the pane mount is releasably secured to the frame by one of locking mechanism, rod part projecting from the frame into a corresponding recess of the pane mount, a magnet part on one of the frame and pane mount and a metal part on the other of the frame and pane mount to which the magnet part is magnetically attracted.

29. The interior pane unit of claim 26 further comprising a pane connected to the pane mount.

30. The interior pane unit of claim 26 wherein one of the frame and the pane mount has at least one tongue and the other of the frame and the pane mount has at least one channel, the at least one tongue releasably receivable within the at least one channel.

31. An interior pane system comprising
a frame unit,
a pane unit connected to the unit,
the pane unit having a pane,
the frame unit applicable to a window, the window having an exterior pane, the window having a window opening,
the frame unit sized and configured for positioning at the window opening.

32. The interior pane system of claim 31 including the window.

33. The interior pane system of claim 31 including a window cover connected to the frame unit.
